(19) United States
(12) Patent Application Publication
(10) Pub. No.: US 2009/0206179 A1
(43) Pub. Date: Aug. 20, 2009

(54) SHOWERHEAD FOR DOMESTIC PURPOSE

(76) Inventor: Fabrizio Nobili, San Vittore (CH)

Correspondence Address: SEED INTELLECTUAL PROPERTY LAW GROUP PLLC, 701 FIFTH AVE, SUITE 5400, SEATTLE, WA, 98104, US

(21) Appl. No.: 12/369,523

(22) Filed: Feb. 11, 2009

(30) Foreign Application Priority Data
Feb. 13, 2008 (EP) 08002655.2

(51) Int. Cl. B05B 1/16

(52) U.S. Cl. 239/443

(57) ABSTRACT

A handshower for domestic use comprising a body delimiting a water distribution chamber having at least two distinct outlets, a diffuser comprising at least two delivery zones each in fluid communication with a respective outlet and a shutter arranged in the distribution chamber for selectively blocking a fluid path towards at least one of the two outlets. The handshower comprises a rigid shell fitted watertight onto the body and onto the diffuser, electric operation means of the shutter, a hydraulically insulated and sealed seat, delimited by the rigid shell on the body and on the diffuser, for the accommodation of the electric operation means, an opening on the rigid shell for access into said seat and a watertight closing keypad of said opening, for enabling the electric operation means.

### BACKGROUND

1. Technical Field

The present invention relates to a handshower for domestic use comprising a body delimiting a water distribution chamber having at least two distinct outlets, a diffuser comprising at least two delivery zones each in fluid communication with a respective outlet and a shutter arranged in the distribution chamber for selectively blocking a fluid path towards at least one of the two outlets.

2. Description of the Related Art

As well known to one skilled in the art, currently there are domestic handshowers provided with controls for selecting the water delivery mode, for example switching to a peripheral rain jet or to a central cohesive jet.

In particular, these handshowers comprise a body delimiting a water distribution chamber having at least two distinct outlets, and a diffuser with at least two distinct delivery zones, each in fluid communication with a respective outlet, for providing the various delivery modes.

The distribution chamber can also end in three or more distinct outlets, in fluid communication with the respective delivery zones of the diffuser, corresponding to various delivery modes.

In the examples mentioned above, selection of the delivery mode is performed by means of a shutter, arrangable in the distribution chamber for selectively blocking a fluid path towards at least one of the outlets.

In particular, shutter controls are generally buttons, arranged on the handle of the handshower, which control shutter mechanical operation means, for selecting a preset position of the shutter in the distribution chamber.

Such controls suffer the considerable drawback of being particularly cumbersome given that they are required to transfer a pressure applied manually onto the button to the operation means, in order to move the shutter in the distribution chamber. In particular, the buttons must be dimensioned in such a manner to allow simple and immediate pressing by the operator using a finger.

The technical problem on which the present invention is based is that of improving, simplifying and enhancing the functionality of the selection operations of a handshower, overcoming the drawbacks affecting handshowers according to the prior art.

### BRIEF SUMMARY

The solution idea on which the present invention is based is that of providing a rigid shell for a body and a diffuser for a handshower, watertight on the body and on the diffuser, and delimiting a hydraulically sealed seat for the accommodation of the electric operation means of the shutter, such seat being accessible through an opening on the rigid shell covered by a keypad having the double purpose of closing the opening on the shell in a watertight manner and controlling the electric operation means of the shutter.

In particular, the opening is made on the handle surface of the rigid shell and accommodates in a closing manner the keypad which is shaped to be recessed into the opening of the shell, in a watertight manner. The keypad is provided with a special gasket for preventing water from seeping into the accommodation seat.

The electric operation means comprises an electronic board provided with at least one pressure sensor which can be operated through the keypad, and an electric motor connected to the electronic board for moving the shutter in the distribution chamber.

According to such a solution idea, the technical problem is overcome by a handshower comprising:

a rigid shell fitted in a watertight manner onto the body and the diffuser,

an electric operation means for operating the shutter,

a hydraulically insulated and sealed seat, delimited by said rigid shell on the body and on the diffuser, for the accommodation of the electric operation means;

an opening on the rigid shell for access into said seat; and

a watertight closing keypad of said opening for enabling the electric operation means.

The present invention attains the considerable advantage of being capable of accommodating electric operation means directly installed on board the handshower and allowing a user to select the jet through a minimum pressure on the keypad.

Advantageously, the electronic board can be connected both to the electric connection means mounted onboard the handshower, but also to electric connection means mounted externally, for example for the adjustment of the water temperature or flow rate. As a matter of fact, one or more pressure sensors of the electronic board can be provided to control also the electric operation means mounted external to the handshower.

Advantageously, the handshower allows for the grouping of a plurality of buttons on the keypad, associated to the pressure sensors, arranged very closely, adjacent to each other and of small dimensions.

Advantageously, application of undue pressure on the buttons is not required to enable the electric operation means.

Characteristics and advantages of the handshower according to the present invention shall be clear from the description, outlined hereinafter, of one of its embodiments, provided for indicative and non-limiting purposes with reference to the attached drawings.

### BRIEF DESCRIPTION OF THE SEVERAL VIEWS OF THE DRAWINGS

FIG. 1 shows a perspective and partially sectional view of a diffuser-body assembly of a handshower according to the present invention.

FIG. 2 shows a different perspective view of the diffuser-body assembly of the handshower of FIG. 1.

FIG. 3 shows a side and partially sectional view of a rigid shell of the handshower according to the present invention.

FIG. 4 shows a front view of the rigid shell of FIG. 3.

FIG. 5 shows a bottom view of the rigid shell of FIG. 3.

FIG. 6 shows a top view of the rigid shell of FIG. 3.

FIG. 7 shows a side and sectional view of a keypad of the handshower according to the present invention.

FIG. 8 shows a section of a handshower according to the invention complete with body-diffuser assembly and rigid shell.

### DETAILED DESCRIPTION

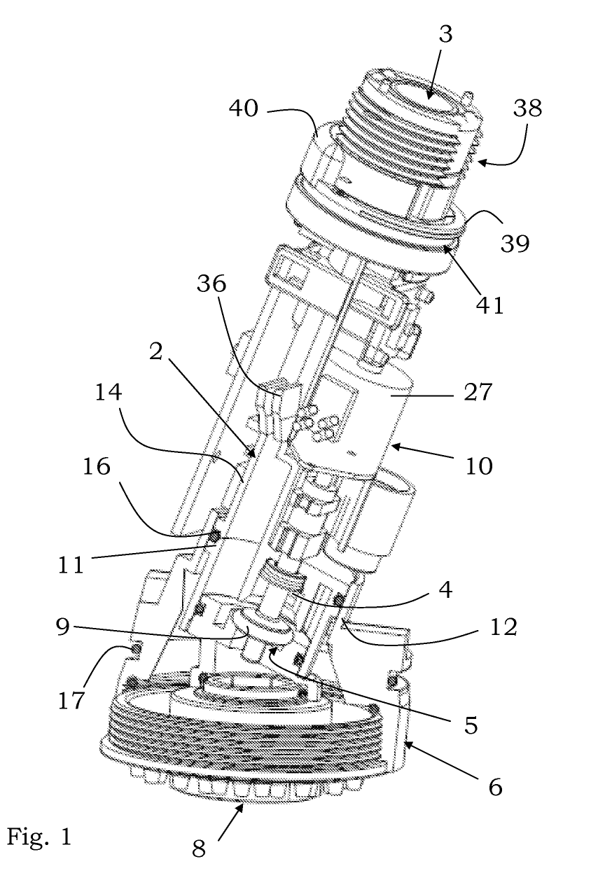

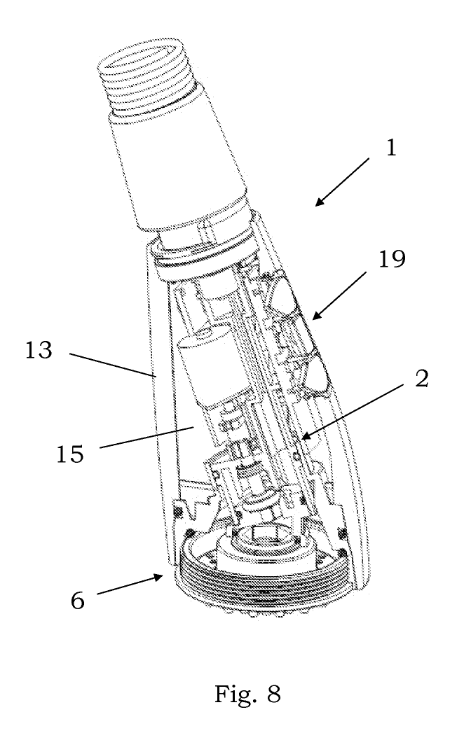

Referring to the attached drawings, a handshower for domestic use, which essentially (FIG. 8) comprises a body 2, a diffuser 6 and a rigid shell 13 fitted sealingly on said body 2 and said diffuser 6 is schematically represented and globally indicated with reference number 1. As represented in more detail in FIG. 1 the body 2 defines a water distribution chamber 3, provided with a water inlet receiving water from an intake pipe and at least two distinct outlets 4, 5.

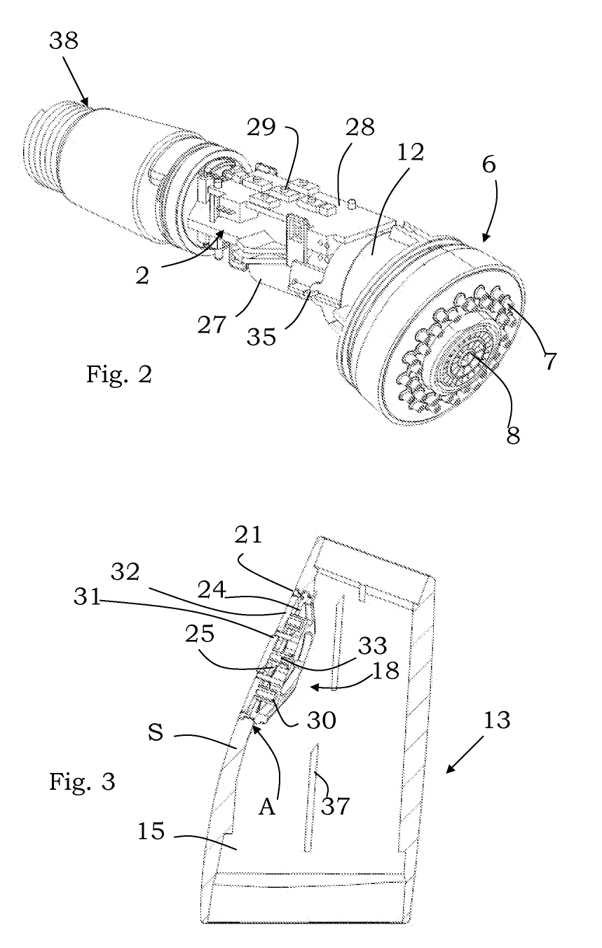

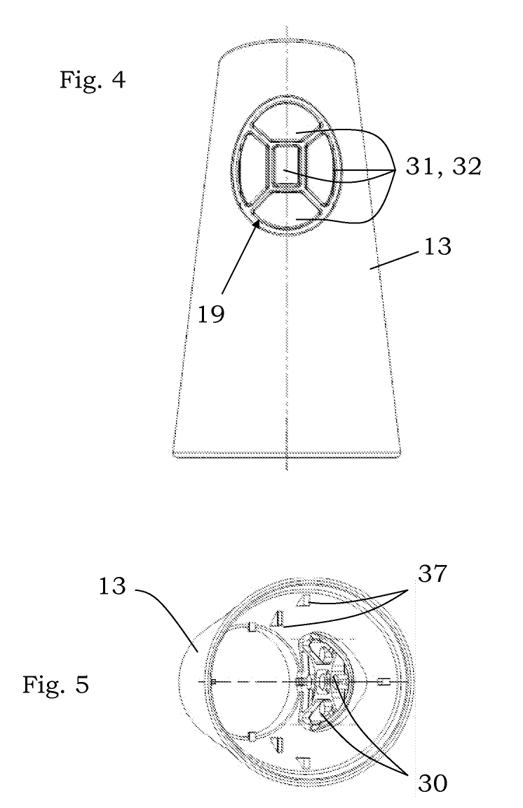

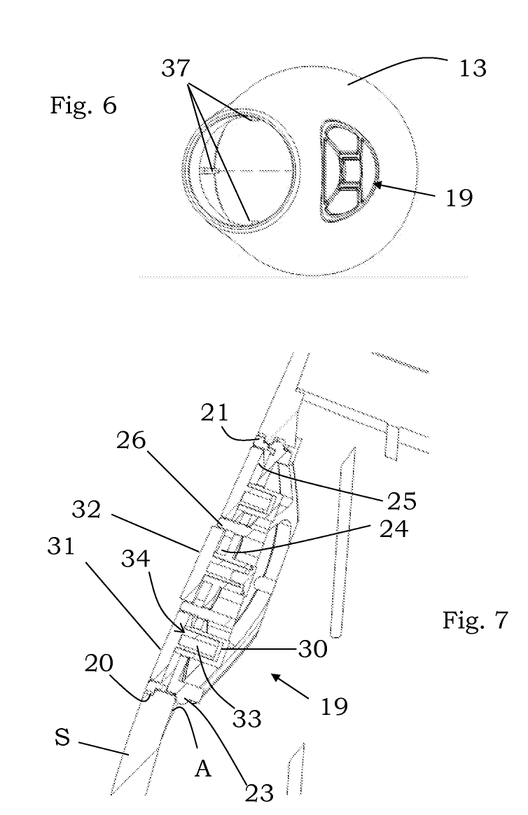

The diffuser 6 comprises at least two distinct delivery zones 7, 8 (see FIG. 2) each in fluid communication with a respective outlet 4, 5 of the body 2. The two delivery zones 7, 8 provide delivery in two different modes, for example a cohesive jet from a central nozzle associated to a first delivery zone 8, and a peripheral jet obtained through a plurality of peripheral nozzles associated to a second delivery zone 7 and distributed to form a crown around the central nozzle.

The distribution chamber 3 can also end in three or more distinct outlets, in fluid communication with respective delivery zones of the diffuser, corresponding to various delivery modes.

The handshower 1 comprises a shutter 9 moveably guided in the distribution chamber 3 from and towards an accommodation seat located to interfere with the fluid path between the inlet of the distribution chamber 3 and a respective one of the outlets 4, 5.

When the shutter 9 is in the accommodation seat interfering with the fluid path towards the first outlet 4, the handshower delivers water in a rain mode through the first delivery zone 7; otherwise the handshower delivers water in a cohesive mode through the second delivery zone 8.

The rigid shell 13 is fitted in a watertight manner onto the body 2 and the diffuser 6, delimiting, with the body 2 and the diffuser 6, a hydraulically sealed and watertight accommodation seat 15.

The rigid shell 13 adheres to a portion of the diffuser 6 comprising an annular seat which accommodates a first gasket 17, fitted sealingly between the shell 13 and the diffuser 6. As observable in the figures, the rigid shell 13 does not interfere with the delivery zones 7, 8 of the diffuser 6 but prevents the water delivered by it from penetrating into the hydraulically insulated seat 15.

In a preferred embodiment, the rigid shell 13 is made of a hollow and substantially cylindrical or frusto-conical shaped body, fitted sealingly into the assembly of the body 2 and diffuser 6, the sealing being guaranteed by the first gasket 17 and by a bushing also provided with a gasket 41.

According to the present invention, the handshower 1 comprises electric operation means 10 of the shutter 9, fixed into the hydraulically insulated seat 15.

Such electric operation means 10 comprises an electric motor 27 for operating the shutter 9 and an electronic board 28 connected to the electric motor 27 for controlling the electric motor 27.

In particular, the electric motor 27 and the electronic board 28 are mounted onto the body 2 and arranged oppositely with respect to it.

An opening 18 (FIG. 3) is made on the rigid shell 13 for access to the hydraulically sealed seat 15 and a keypad 19 is fixed for watertight closure of the opening 18.

The opening 18 is peripherally provided with an abutment recess 20 (FIG. 7) for accommodating and supporting the keypad 19 in such a manner such to be substantially level with the external surface of the rigid shell 13. In practice, the keypad is inserted to cover the opening 18 with an edge supported by the abutment recess 20.

The keypad 19 is provided with a fourth gasket 23, integrated into a single piece with the keypad 19, which adheres within the rigid shell 13 and seals it.

The edge and the gasket 23 are shaped in a thickness of the keypad 19 and delimit, in such thickness, an annular seat snap-fitted into the opening 18 of the rigid shell 13.

The keypad 19 comprises at least one elastically deformable portion 24 for enabling the electric operation means 10.

In particular, the electronic board 28 comprises at least one pressure sensor 29 which can be operated by a corresponding elastically deformable surface portion 24, 25.

More pressure sensors can be provided on the electronic board 28 to enable further electric operation means, for example for the adjustment of various delivery modes, for opening or closing the jet or for the adjustment of the flow rates and/or temperature.

In other words, the pressure sensors 29 on the electronic board can be connected to the electric motor, for positioning the shutter 9 in the distribution chamber 3 but they can also be connected to other electric operation means 10.

In such a case, the keypad 19 comprises one or more rigid ribs 26 for separating two or more elastic surface portions, which are separately deformable 24, 25.

Substantially, a plurality of pressure sensors 29 of the electronic board 28 correspond to respective elastically deformable surface portions of the keypad 19.

In particular, each elastically deformable surface portion 24 of the keypad 19 comprises a respective socket 30 with a bottom substantially at contact with the pressure sensor 29.

The gasket 23, the rigid ribs 26, and the elastically deformable surface portions 24, 25 and the socket 30 are integrated into a single piece.

In particular, the gasket 23 and the elastically deformable portions 24, 25 are made of rubber. Advantageously, the rubber-made gasket 23 is elastically deformable in such a manner to be force-passed through the opening 18, when the snap-fitting the keypad 19, positioning itself adhering and in a sealing manner, in the rigid shell 13.

The elastically deformable surface portions 24, 25 made of rubber allow to transfer a preset pressure onto the pressure sensors 29 of the electronic board 28.

The rigid ribs 26 and the socket 30 are made of polypropylene and glass fiber. Also the edge of the keypad which is arranged level with the opening 18 is made of polypropylene and glass fiber.

Advantageously, the edge made of polypropylene and glass fiber prevents the formation of mold. Preferably the glass fiber makes up for 30% and it avoids the formation of mold, alongside providing a considerable resistance against chemical agents due to, for example, use of detergents and the like.

A man skilled in the art is capable of realizing that various modifications and variants can performed on the present invention without departing from the scope of the same.

For example, in an alternate embodiment of the present invention, an electronic board is also connected to electric operation means located externally to the handshower, under the sink or in a wall recessed and hydraulically insulated seat. In this alternative embodiment, the cabling between the electronic board held in the accommodation seat 15 and the external handshower operation means is implemented by means of a specific connector of the type described in the EP 06014030.8 patent application number of the same Applicant.

The keypad 19 comprises at least one button 31, 32 coupled to a respective elastically deformable surface portion 24, 25 and comprising a pin 33 inserted into an opening 34 of the socket.

The body 2, is bayonet-fitted into the diffuser 6. In particular, an end portion 11 of the body 2, comprising the outlets 4, 5, is associated and fitted into a portion 12 of the diffuser 6 in such manner that the outlets 4, 5 of the body 2 convey the water coming from the distribution chamber 3 inside the diffuser 6 and towards the respective delivery zones 7, 8.

A sealing gasket is inserted into a further annular seat of the body 2 for sealing with the diffuser 6, preventing water from seeping from the diffuser 6 into a portion of the body 2 not inserted into the diffuser 6.

The assembly of the body 2 with the diffuser 6 and the rigid shell is extremely simple.

The end portion 11 of the body 2 is bayonet-fitted into the portion 12 of the diffuser 6 and it allows self-centering of the outlets 4, 5 of the body 2 towards the respective delivery zones 7, 8 of the diffuser 6.

The end portion 11 of the body 2 and the portion 12 of the diffuser 6 are fixed through a stud 35 passing through the respective holes of the end portion 11 and of the portion 12 of the diffuser 6 which are already aligned in the self-centering position.

The diffuser 6 and the body 2 comprise guides 36 and the rigid shell 13 comprises respective slides 37 for proper positioning of the rigid shell 13 on the diffuser 6 and on the body 2. In particular, when mounting the handshower 1, the slides 37 of the rigid shell 13 are channeled in the respective guides 36 of the body 2 and of the diffuser 6. In this manner, the rigid shell 13, fitted onto the portion 12 of the diffuser through the guides 36, is self-centered both with respect to the body 2, and with respect to the diffuser 6.

In particular, the elastically deformable surface portions 24, 25 of the keypad 19, in the self-centering portion of the rigid shell 13 on the body 2, are substantially at contact with the pressure sensor 29 of the electronic board.

A second end portion 38 of the body 2, oppositely positioned with respect to the first end portion 11, is used for connecting the water intake pipe towards the distribution chamber 3.

The bushing 40 comprises an annular seat accommodating a second gasket 41 which serves as a sealing between it and the rigid shell 13. Also, the portion of the body 2 comprises an annular seat for a third gasket 39 which is fitted sealingly between the bushing 40 and the body 2.

The bushing 40 is bayonet-coupled with the body 2 and allows a particularly easy mounting of the rigid shell onto the body 2 and onto the diffuser 6. In particular, the rigid shell 13 comprises a radial element which interferes with the bushing 40, hence, when coupling the bushing 40 onto the body 2, the rigid shell 13 is forcefully pushed with the radial element perfectly adhering onto the first gasket 17 of the diffuser 6.

Furthermore, provided in the seat 15, are silicone gel cartridges which eliminate humidity completely, guaranteeing that such accommodation seat 15 is substantially in a dry environment, particularly adapted for proper operation of the electric motor 27, of the electronic board 28 and substantially of all the electronic components provided for in the handshower 1.

The present invention attains the considerable advantage of being capable of accommodating electric operation means directly installed on board the handshower and allowing to select the jet through a minimum pressure on the keypad.

Advantageously, the electronic board can be connected both to the electric connection means mounted onboard the handshower, and to the electric connection means mounted on it externally, for example for the adjustment of the water temperature or flow rate. As a matter of fact, one or more pressure sensors of the electronic board can be provided to control also the electric operation means mounted external to the handshower.

Advantageously, the invented handshower allows to group a plurality of buttons on the keypad, associated to the pressure sensors, arranged very closely, adjacent to each other and of small dimensions.

Advantageously, application of undue pressure on the buttons is not required to enable the electric operation means.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A handshower for domestic use having a body delimiting a water distribution chamber having at least two distinct outlets, a diffuser having at least two delivery zones each in fluid communication with a respective outlet, a shutter arranged in the distribution chamber for selectively blocking a fluid path towards at least one of the two outlets, the handshower comprising:
a rigid shell fitted in a watertight manner onto the body and the diffuser,
electric operation means for actuating the shutter,
a hydraulically insulated and sealed seat, delimited by the rigid shell on the body and the diffuser, for the accommodation of the electric operation means;
an opening on the rigid shell for access into said seat, and
a watertight closing keypad of said opening, for enabling the electric operation means.

2. The handshower according to claim 1 further comprising a first gasket fitted sealingly between the rigid shell and the diffuser.

3. The handshower according to claim 1 further comprising a bushing fitted sealingly between the body and the rigid shell.

4. The handshower according to claim 3 further comprising a second gasket fitted sealingly between the rigid shell and the bushing, and a third gasket fitted sealingly between the bushing and the body.

5. The handshower according to claim 1 wherein the opening is peripherally provided with an abutment recess for accommodating and supporting the keypad in such a manner that the keypad is leveled with the external surface of the rigid shell.

6. The handshower according to claim 5 wherein said keypad is snap-fitted into said opening.

7. The handshower according to claim 1 wherein said keypad is provided with a fourth sealing gasket on said opening.

8. The handshower according to claim 7 wherein said fourth gasket is integrated into a single piece with the keypad.

9. The handshower according to claim 1 wherein the keypad comprises at least one elastically deformable surface portion for enabling the electric operation means.

10. The handshower according to claim 9 wherein said keypad comprises one or more rigid ribs for separating two or more elastically deformable surface portions.

11. The handshower according to claim 1 wherein said electric operation means comprise an electric motor for operating said shutter.

12. The handshower according to claim 11 wherein said electric operation means comprise an electronic board electrically connected to said electric motor.

13. The handshower according to claim 12 wherein said body is arranged between said electric motor and said electronic board.

14. The handshower according to claim 13 wherein the electronic board comprises at least one pressure sensor which can be operated by a corresponding elastically deformable surface portion.

15. The handshower according to claim 14 wherein the elastically deformable surface portions of said keypad comprise a socket with a bottom substantially at contact with said pressure sensor.

16. The handshower according to claim 7 wherein said gasket, said rigid ribs, said elastically deformable surface portions and said socket are integrated into a single piece.

17. The handshower according to claim 7 wherein said gasket and said elastically deformable surface portions are made of rubber.

18. The handshower according to claim 10 wherein said rigid ribs and said socket are made of polypropylene and glass fiber.

19. The handshower according to claim 1 wherein said body is bayonet-fitted into the diffuser.
